(19) United States
(12) Patent Application Publication
(10) Pub. No.: US 2010/0177498 A1
(43) Pub. Date: Jul. 15, 2010

(54) LIGHT SOURCE UNIT AND DISPLAY DEVICE HAVING THE SAME

(76) Inventors: DONG-WAN CHOI, Seoul (KR); Hyo-Sang Yang, Yongin-si (KR); Hee-Kwon Eun, Hwaseong-si (KR); Seung-Jun Lee, Seoul (KR)

Correspondence Address: F. CHAU & ASSOCIATES, LLC, 130 WOODBURY ROAD, WOODBURY, NY, 11797, US

(21) Appl. No.: 12/603,198

(22) Filed: Oct. 21, 2009

(30) Foreign Application Priority Data
Jan. 9, 2009 (KR) 10-2009-0002023

(51) Int. Cl. G09F 13/04; F21V 1/14

(52) U.S. Cl. 362/97.1; 362/257

(57) ABSTRACT

A light source unit configured to shield electromagnetic interference (EMI) due to high frequencies radiated from internal circuits and a display device having the light source unit is provided. The display device includes a display panel displaying an image, a light source supplying light to the display panel, and a first circuit board having the light source mounted thereon and an EMI shielding pattern formed on at least one surface thereof.

### CROSS-REFERENCE TO RELATED APPLICATION

This application claims priority to and the benefit of Korean Patent Application No. 10-2009-0002023 filed on Jan. 9, 2009 in the Korean Intellectual Property Office, the entire content of which is incorporated by reference herein.

### BACKGROUND OF THE INVENTION

1. Field of the Invention

The present disclosure relates to light source units and display devices having the same, and more particularly, to a light source unit configured to shield electromagnetic interference (EMI) due to high frequencies radiated from internal circuits, and a display device having the light source unit.

2. Discussion of the Related Art

Currently, liquid crystal display (LCD) devices are some of the most widely used flat panel display (FPD) devices. The LCD device is provided with two substrates on which field-generating electrodes are formed, and a liquid crystal layer that is interposed between the substrates. In the LCD device, a voltage is applied to the electrodes to rearrange the liquid crystal molecules of the LCD device, thereby controlling the quantity of transmitted light.

Typically, a display device includes thin film transistors (TFTs) for switching each pixel. Each TFT constitutes a switching device having three terminals including a gate terminal to which a switching signal is applied, a source electrode to which a data voltage is applied, and a drain electrode to which an output signal of the drain electrode is applied. Various driver circuits are provided in the display device to drive the TFTs. The driver circuits are typically mounted on a printed circuit panel or a display panel. Alternatively, the driver circuits may be mounted in the form of IC chips to increase the integration level. The driver circuits, however, may radiate high frequencies and result in undesirable EMI which ultimately adversely affects various components or even the human body.

In particular, since display devices are mounted on a variety of mobile devices, the rapid proliferation of portable electronic products has increased the risk of exposure to EMI. Accordingly, a need exists for a display device having EMI shielding capability.

### SUMMARY OF THE INVENTION

Exemplary embodiments of the present invention provide a light source unit configured to shield EMI due to high frequencies radiated from internal circuits.

Exemplary embodiments of the present invention also provide a display device configured to shield EMI due to high frequencies radiated from internal circuits.

According to an exemplary embodiment of the present invention, there is provided a light source unit including a light source, and a circuit board having the light source mounted thereon and having EMI shielding pattern formed on at least one plane thereof.

According to an exemplary embodiment of the present invention, there is provided a display device that includes a display panel that displays an image, a light source that supplies light to the display panel, and a first circuit board having the light source mounted thereon and an EMI shielding pattern formed on at least one surface thereof.

According to an exemplary embodiment of the present invention, there is provided a display device including a display panel that displays an image, a light source that supplies light to the display panel, a first circuit board having the light source mounted thereon, a flexible film connected to the display panel, and a second circuit board connected to the flexible film and having an EMI shielding pattern formed on at least one plane thereof.

The EMI shielding pattern may be connected to a ground power supply. The first circuit board may further include an anode pattern and a cathode pattern for supplying power to the light source. The anode pattern and the cathode pattern may be formed on the same plane as the EMI shielding pattern. At least one of the anode pattern and the cathode pattern may be formed on a plane opposite to a plane where the EMI shielding pattern is formed. At least one of the anode pattern and the cathode pattern may be formed along the edge of the first circuit board. The EMI shielding pattern may be surrounded by at least one of the anode pattern and the cathode pattern. The anode pattern and the cathode pattern may overlap the EMI shielding pattern. The display device may further include a driving circuit for driving the display panel provided on the display panel. The EMI shielding pattern may be disposed to overlap the driving circuit. The display device may further include an EMI shielding film attached to the display panel to overlap the driving circuit, wherein the driving circuit is disposed between the EMI shielding film and the EMI shielding pattern. The EMI shielding pattern may be disposed between the display panel and the light source.

### BRIEF DESCRIPTION OF THE DRAWINGS

The above and other features will become more apparent by describing in detail exemplary embodiments of the present invention with reference to the attached drawings in which:

FIG. 1 is an exploded perspective view of a display device according to an exemplary embodiment of the present invention;

FIG. 2 is a cross-sectional view of the display device shown in FIG. 1 taken along a line II-IP;

FIG. 3A is a perspective view of a light source unit included in the display device shown in FIG. 1;

FIG. 3B is a bottom perspective view of a light source unit included in the display device shown in FIG. 1;

FIG. 4 is a bottom view of a light source unit included in the display device shown in FIG. 1;

FIG. 5 is a cross-sectional view of the light source unit shown in FIG. 3A taken along a line V-V′;

FIG. 6 is an enlarged view of a region A of the display device shown in FIG. 2;

FIG. 7A is a photograph illustrating EMI measured from the bottom of the light source unit after removing an EMI shielding pattern from the display device shown in FIG. 1;

FIG. 7B is a photograph illustrating EMI measured from the bottom of the light source unit of the display device shown in FIG. 1;

FIG. 8A is a perspective view of a light source unit included in a display device according to an exemplary embodiment of the present invention;

FIG. 8B is a bottom perspective view of a light source unit shown in FIG. 8A;

FIG. 9 is a cross-sectional view of the light source unit shown in FIG. 8A taken along a line IX-IX′;

FIG. 10 is an exploded perspective view of a display device according to an exemplary embodiment of the present invention;

FIG. 11 is a cross-sectional view of the display device shown in FIG. 10 taken along a line XI-XI′; and

FIG. 12 is a perspective view of a second circuit board included in the display device shown in FIG. 10.

### DETAILED DESCRIPTION OF THE EXEMPLARY EMBODIMENTS

The exemplary embodiments of the present invention may take many different forms and should not be construed as being limited to the embodiments set forth herein. Like reference numerals refer to like elements throughout the specification.

Hereinafter, a display device according to exemplary embodiments of the present invention will be described with reference to the accompanying figures.

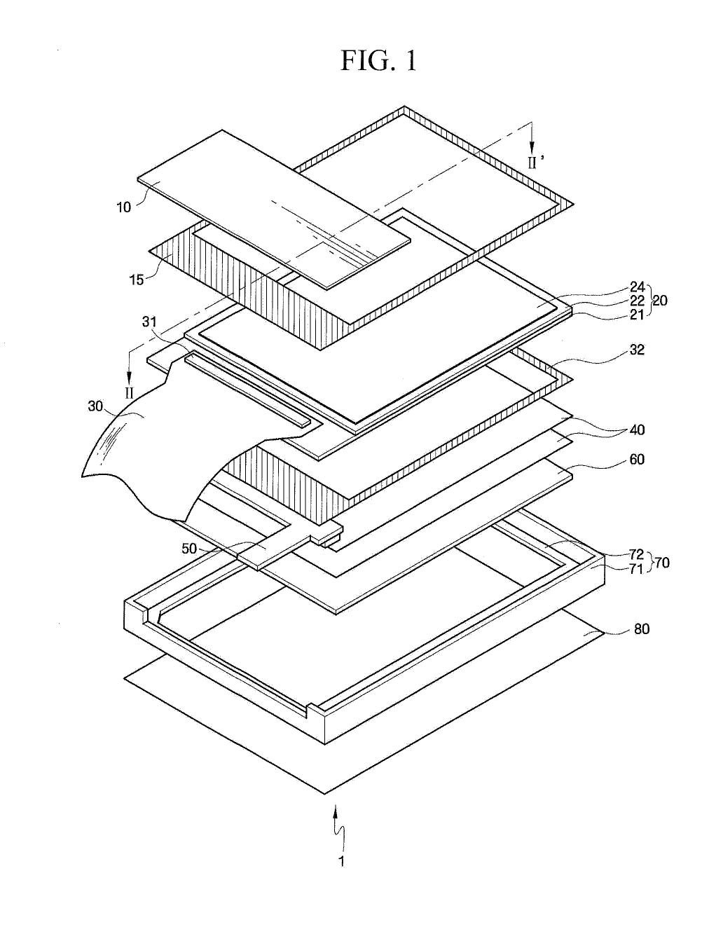

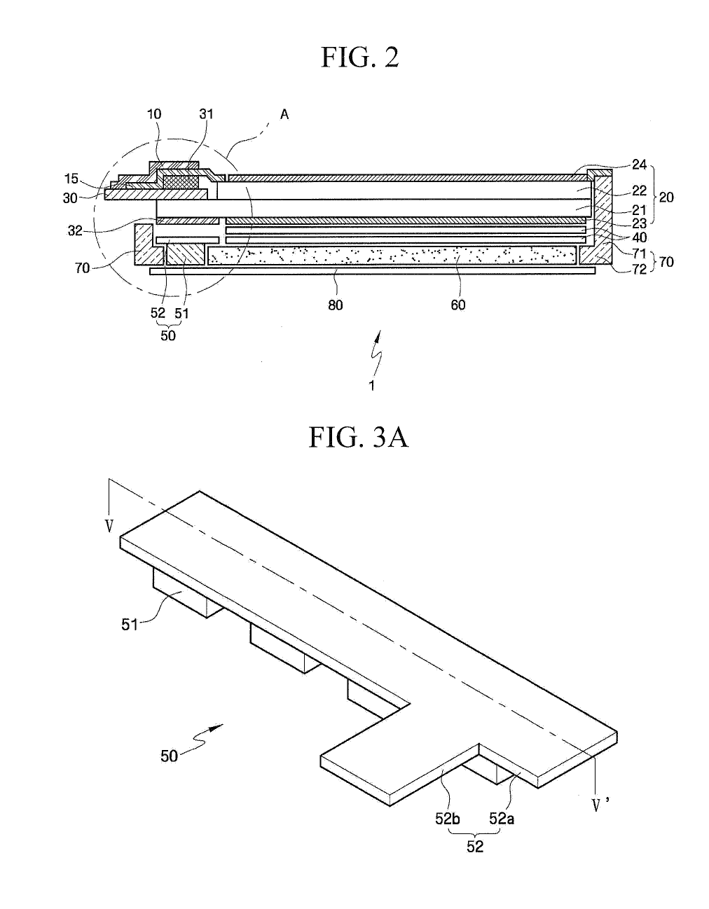

Referring now to FIGS. 1 and 2, the display device 1 according to an exemplary embodiment of the present invention includes a display panel 20, optical sheets 40, a light guide plate 60, a frame 70, a reflection sheet 80, an EMI shielding film 10 and a light blocking film 15.

The display panel 20 includes a lower substrate 21 and an upper substrate 22 facing the lower substrate 21. The lower substrate 21 includes gate lines (not shown), data lines (not shown), TFTs, and pixel electrodes. The upper substrate 22 has color filters, black matrixes, and a common electrode. The color filters and the common electrode are not necessarily formed on the upper substrate 22. Rather, the color filters and the common electrode may be formed on the lower substrate 21.

A liquid crystal layer (not shown) is interposed between the lower substrate 21 and the upper substrate 22.

If an electric field is formed between the lower substrate 21 and the upper substrate 22, liquid crystal molecules rotate to then readjust the transmittance of the display panel 20, thereby displaying an image on the display panel 20.

The display panel 20 includes first and second polarizers 23, 24 disposed on outer sides of the lower and upper substrates 21, 22 respectively.

A flexible film 30 is attached to the display panel 20 and connected to the gate lines and the data lines, respectively. The flexible film 30 is attached to one side of the lower substrate 21.

Various driving circuits may be mounted on the lower substrate 21. Examples of the driving circuits include a circuit for a gate voltage or a data voltage for applying the gate lines and the data lines, respectively. The driving circuit may be directly formed on the display panel 20. Alternatively, the driving circuit may be in the form of the driving chip 31 to then be mounted on the lower substrate 21, as shown in FIG. 1.

The driving chip 31 is formed on a flexible film 30, instead of being directly mounted on the display panel 20. Alternatively, the driving chip 31 may be formed on a separate driving circuit board (not shown) and a driving voltage may be applied to the display panel 20 through the flexible film 30.

Since the driving chip 31 is highly integrated and radiates high frequencies, electromagnetic radiation is radiated. The structure for shielding the EMI is described in detail below.

A light source unit 50 supplies light to the display panel 20, and includes a light source 51 and a first circuit board 52.

A cold cathode fluorescent lamp (CCFL), a hot cathode fluorescent lamp (HCFL), an external electrode fluorescent lamp (EEFL) may be used as the light source 51. When applied to an ultrathin, ultralight product, such as a mobile display device 1, a light emitting diode (LED) may be used as the light source 51.

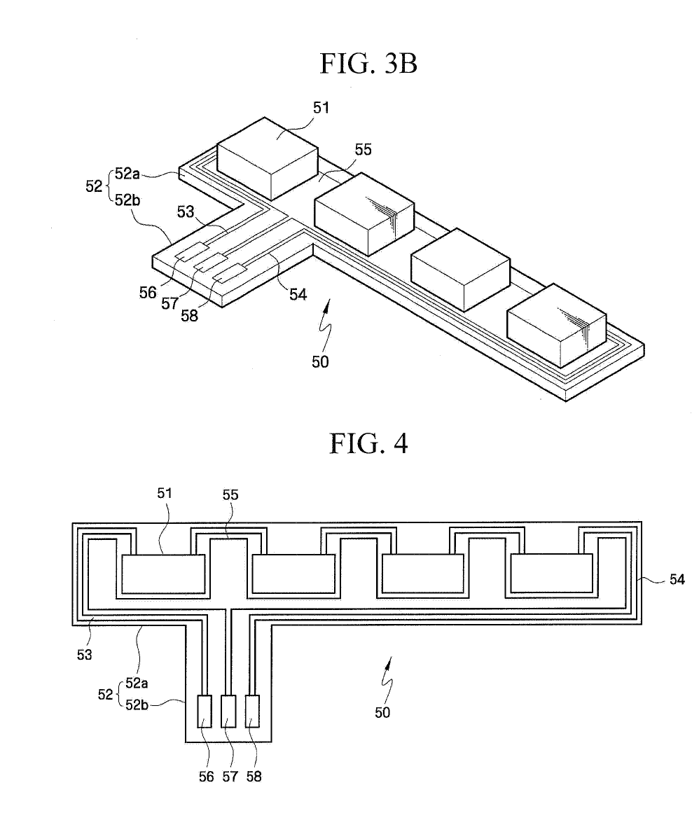

Referring to FIGS. 3A and 3B, the light source unit 50 will be described in more detail. The light source 51 is mounted on the first circuit board 52. The first circuit board 52 may be formed using a hard printed circuit board or a flexible film.

An anode pattern 53 and a cathode pattern 54 for applying power to the light source 51 are formed on the first circuit board 52. The light source 51 may include, for example, light emitting diodes serially connected by the anode pattern 53 and the cathode pattern 54.

The anode pattern 53 and cathode pattern 54 are connected to an anode pad 56 and a cathode pad 58 formed at one side of the first circuit board 52. The anode pad 56 and the cathode pad 58 connect the light source unit 50 to an external power supply.

The EMI shielding pattern 55 are formed on the same plane as the anode pattern 53 and the cathode pattern 54 at the first circuit board 52. The EMI shielding pattern 55 serves to shield electromagnetic radiation to exert the EMI shielding effect.

The EMI shielding pattern 55 is formed on the first circuit board 52 by patterning together with the anode pattern 53 and the cathode pattern 54. The EMI shielding pattern 55 is formed on the light source unit 50, and the light source unit 50 is disposed to overlap the driving chip 31 of the display panel 20, so that the EMI shielding pattern 55 overlaps the driving chip 31.

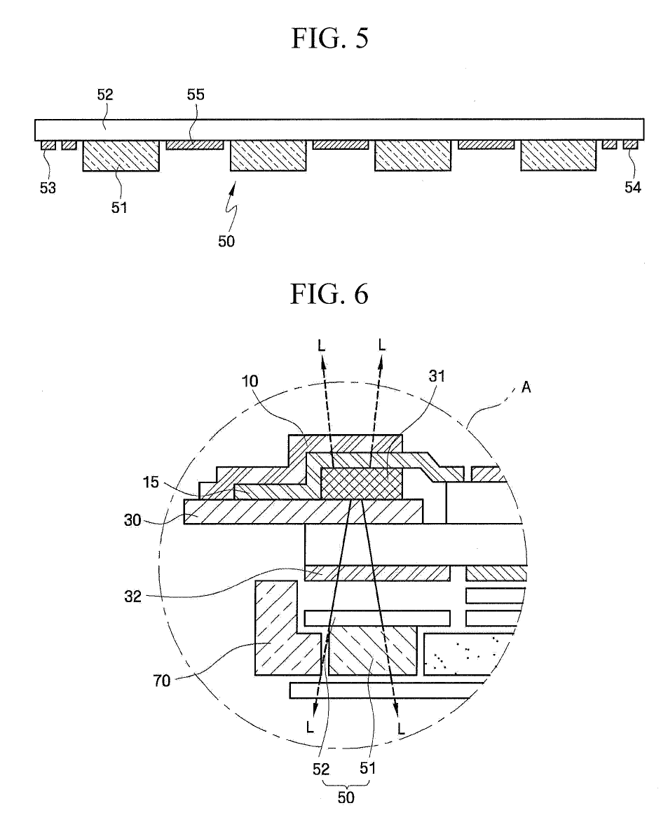

Referring to FIGS. 4 and 5, in an exemplary embodiment the EMI shielding pattern 55 is formed as widely as possible on the first circuit board 52. For example, the EMI shielding pattern 55 is formed throughout most of the areas of one plane of the first circuit board 52, whereas the anode pattern 53 and the cathode pattern 54 are formed on the rest of the areas.

Here, the EMI shielding pattern 55 is formed on the central portion of the first circuit board 52, and at least one of the anode pattern 53 and the cathode pattern 54 is formed to surround the EMI shielding pattern 55. The EMI shielding pattern 55 may be integrally formed throughout the entire surface of the first circuit board 52. That is to say, the anode pattern 53 and the cathode pattern 54 are formed along the edge of the first circuit board 52, and the EMI shielding pattern 55 is formed on the rest of the areas.

The EMI shielding pattern 55 may have various thicknesses according to the necessity. That is to say, when the EMI shielding pattern 55, the anode pattern 53, the cathode pattern 54 are formed simultaneously during batch processing, the EMI shielding pattern 55 may have the same thickness as that of the anode pattern 53 and the cathode pattern 54. However, when the EMI shielding pattern 55, the anode pattern 53 and the cathode pattern 54 are formed independently during individual processing, the EMI shielding pattern 55 may have a thickness greater or smaller than that of the anode pattern 53 and the cathode pattern 54.

The EMI shielding pattern 55 is connected to a ground pad 57, which is then connected to a ground power supply. As described above, when the EMI shielding pattern 55 is connected to the ground power supply, the EMI shielding capability becomes improved.

The first circuit board 52 may be made of a ductile material, such as a flexible film. Here, the EMI shielding pattern 55, the anode pattern 53 and the cathode pattern 54 formed on the first circuit board 52 may also be made of a ductile material, similar to that of the first circuit board 52. The ductility of the EMI shielding pattern 55, the anode pattern 53 and the cathode pattern 54 may be adjusted by components and thicknesses of pattern forming metals.

The first circuit board 52 includes a plane portion 52a and an extension portion 52b. The plane portion 52a is an area where the light source 51, the EMI shielding pattern 55, the anode pattern 53 and the cathode pattern 54 are mounted. The extension portion 52b is an area where the ground pad 57, the anode pad 56 and the cathode pad 58 are formed. The extension portion 52b is connected to an external power source.

The length of the plane portion 52a may be greater than or equal to that of the lateral side of the light guide plate 60 of FIG. 1 so as to mount the light source 51. The plane portion 52a is formed to have a width large enough to overlap the driving chip 31 of FIG. 1.

The extension portion 52b protrudes toward one side of the plane portion 52a. The extension portion 52b has a width and a length to provide sufficient space for receiving the ground pad 57, the anode pad 56 and the cathode pad 58.

Since the light source 51 is mounted on the plane portion 52a, the plane portion 52a is formed harder than the extension portion 52b to prevent movement of the light source 51. In an exemplary embodiment, the plane portion 52a is a hard printed circuit board, and the extension portion 52b is a flexible film connected to the printed circuit board.

In an exemplary embodiment, the plane portion 52a and the extension portion 52b are integrally formed in a flexible film type. The strength of the plane portion 52a can be increased by adjusting the rigidity of the EMI shielding pattern 55 formed on the plane portion 52a. In such an embodiment, the movement of the light source 51 mounted on the first circuit board 52 can be prevented by increasing strength of the plane portion 52a and decreasing the strength of the extension portion 52b. In addition, since the extension portion 52b is made of a ductile material, it provides a wide variety of applications with power supply sources of different locations.

Referring back to FIGS. 1 and 2, the light source unit 50 is formed at one side of the light guide plate 60. In the light source unit 50 formed at one side of the light guide plate 60, the light incident into one side of the light guide plate 60 forms a surface light source, which is referred to as an edge type backlight structure.

The light guide plate 60 guides the light incident into one side of the light guide plate 60 and provides as a uniform surface light source to the display panel 20. The light guide plate 60 may include various scattering patterns or lens patterns.

Optical sheets 40 are interposed between the light guide plate 60 and the display panel 20. The optical sheets 40 are disposed above the light guide plate 60, and diffuse and collect the light transmitted from the light guide plate 60. The optical sheets 40 may include at least one of a diffusion sheet, a prism sheet, and a protective sheet. Alternatively, the optical sheets 40 may be a combination sheet having all functions of these sheets. That is, the combination sheet may be constructed such that it has a diffusion capability at its bottom layer, a prism pattern (not shown) is formed on the bottom layer, and a protective layer (not shown) is formed on the prism pattern. In such a manner, since the optical sheets 40 may encompass all of diffusive and prismatic functions in an exemplary embodiment having a single sheet, the number of components can be reduced, thereby making the display device 1 even slimmer.

An adhesive film 32 is provided between the display panel 20 and the optical sheet 40. The adhesive film 32 is used to adhesively couple the display panel 20 to the frame 70, or to adhesively couple the display panel 20 to the light source unit 50.

The frame 70 accommodates the display panel 20, the optical sheets 40, the light source unit 50 and the light guide plate 60. The frame 70 includes a sidewall portion 71 surrounding its four walls and a seating portion 72 extending to the interior side from the sidewall portion 71. The display panel 20 is seated on the seating portion 72 and enclosed by the sidewall portion 71. The frame 70 may be formed by molding.

The reflection sheet 80 is disposed below the light guide plate 60. The optical sheets 40 may include a diffusion sheet, a first prism sheet, and a second prism sheet. The reflection sheet 80 may be disposed below the frame 70, and reflects light passing downward through the bottom surface of the light guide plate 60 upwards from the light guide plate 60. The reflection sheet 80 is made of aluminum, which is a highly reflective material, or a highly reflective organic or inorganic material.

A light blocking film 15 adheres to a top surface of the display panel 20. The light blocking film 15 prevents the light from being leaked to portions other than a display area (not shown) of the display panel 20. In addition, the display panel 20 and the frame 70 can be securely combined to each other by coating an additive agent to one surface of the light blocking film 15. The light blocking film 15 also adheres to the flexible film 30 and the driving chip 31.

The EMI shielding film 10 is attached to the driving chip 31 to shield EMI. That is to say, the EMI radiated below the driving chip 31 is shielded by the EMI shielding pattern 55 and the EMI radiated above the driving chip 31 is shielded by the EMI shielding film 10. Since the driving chip 31 is highly integrated and radiates high frequencies, a large amount of EMI may be generated in the display device 1. As shown in FIG. 6, top and bottom surfaces of the driving chip 31 are surrounded by the EMI shielding film 10 and the EMI shielding pattern 55, thereby preventing the EMI (L) radiated from the driving chip 31 from passing through the EMI shielding pattern 55 and the EMI shielding film 10. The hatched portion of the EMI (L) arrows show that portion which would have been radiated but for the EMI shielding film 10 and the EMI shielding pattern 55. Accordingly, the EMI externally radiated from the display device 1 can be noticeably reduced.

The EMI shielding film 10 is formed as a conductive film connected to the ground power supply similar to that for the EMI shielding pattern 55. As described above, the EMI shielding effect can be noticeably increased by connecting the EMI shielding film 10 and the EMI shielding pattern 55 to the ground power supply.

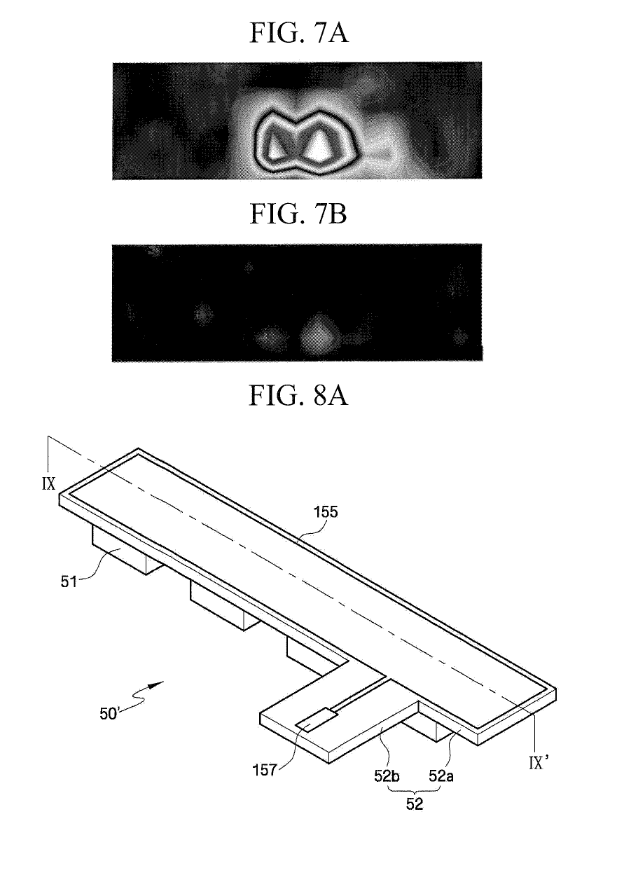

Hereinafter, EMI shielding effects will be described in more detail with reference to FIGS. 7A and 7B. FIG. 7A is a photograph illustrating EMI measured from the bottom of the light source unit after removing an EMI shielding pattern from the display device shown in FIG. 1, and FIG. 7B is a photograph illustrating EMI measured from the bottom of the light source unit of the display device shown in FIG. 1 with the EMI shielding pattern in place.

Referring to FIG. 7A, electromagnetic radiation is photographed from the bottom of the light source unit 50 with an EMI shielding pattern removed. Several contour lines are produced about a driving chip 31 of FIG. 1. Here, the contour line images are produced as boundaries between different shadings. The wider the contour lines indicates the stronger the electromagnetic radiation, while the greater the difference between shadings indicates the stronger the electromagnetic radiation.

In a state in which the EMI shielding pattern is removed, the electromagnetic radiation from the driving chip 31 is almost transmitted through the display device 1. As understood from the contour lines and shading distribution shown in FIG. 7A, very intense electromagnetic radiation is radiated around the driving chip 31.

On the other hand, when the electromagnetic radiation from the bottom of the light source unit 50 including the EMI shielding pattern is photographed, as shown in FIG. 7B, few contour lines are produced, and the shading change is substantially negligible. This means that there is little electromagnetic radiation transmitting through the EMI shielding pattern 55, suggesting that the EMI shielding pattern 55 is effective in shielding the electromagnetic radiation.

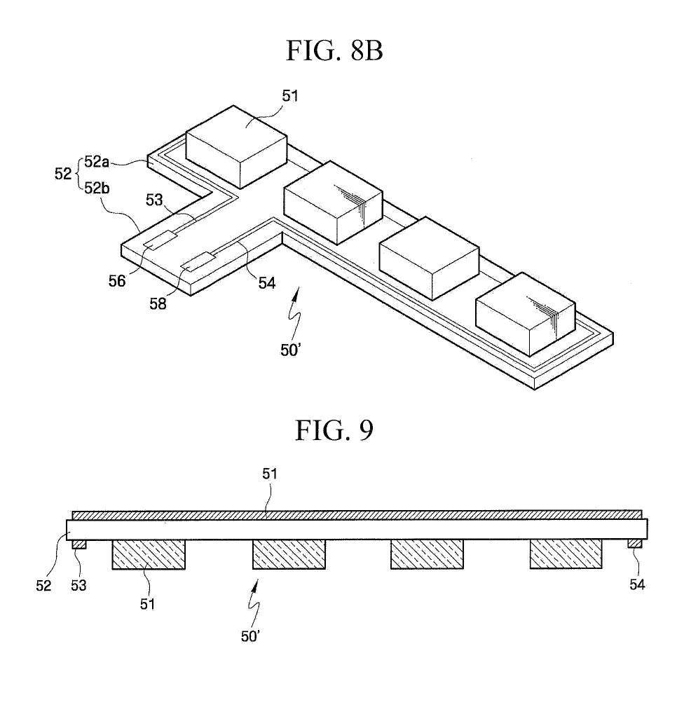

Hereinafter, a display device according to an exemplary embodiment of the present invention will be described in detail with reference to FIGS. 8A through 9. FIG. 8A is a perspective view of a light source unit 50′ included in a display device according to an exemplary embodiment of the present invention. FIG. 8B is a bottom perspective view of a light source unit shown in FIG. 8A. FIG. 9 is a cross-sectional view of the light source unit shown in FIG. 8A taken along a line IX-IX′. For the sake of illustrative convenience, elements identical to those in the previous exemplary embodiments are indicated by identical reference numerals, and detailed descriptions of the identical elements will be omitted.

The light source unit 50′ included in the display device has multiple layers of conductive patterns formed on a first circuit board 52. In more detail, the conductive patterns are formed on both surfaces of the first circuit board 52. That is, an EMI shielding pattern 155 is formed on one surface of the first circuit board 52 and a anode pattern 53 and a cathode pattern 54 is formed on the other surface of the first circuit board 52. As described above, the EMI shielding pattern 155, and the anode pattern 53 and the cathode pattern 54 are formed on both surfaces of the first circuit board 52, respectively, thereby maximizing the space utilization of the first circuit board 52.

In an exemplary embodiment the EMI shielding pattern 155 is formed as widely as possible on the first circuit board 52. In an exemplary embodiment the EMI shielding pattern 155 is formed as close to the driving chip 31 as possible. Accordingly, the anode pattern 53 and the cathode pattern 54 are formed on the first circuit board 52, specifically, on a plane where the light source 51 is mounted, whereas the EMI shielding pattern 155 is formed on the plane opposite to that where the light source 51 is mounted.

The EMI shielding pattern 155 is formed throughout the entire surface of the first circuit board 52. Alternatively, the EMI shielding pattern 155 may be formed on every plane of the first circuit board 52, irrespective of where the light source 51 is formed. Therefore, the area of the EMI shielding pattern 155 can be maximized, and the EMI shielding capability can be further improved without particular restriction on locations.

At least one of the anode pattern 53 and the cathode pattern 54 is formed on a plane opposite to a plane where the EMI shielding pattern 155 is formed.

The EMI shielding pattern 155 is connected to a ground pad 157 formed at one side of the first circuit board 52. The ground pad 157 is formed on a different plane from the anode pad 56 and the cathode pad 58. The ground pad 157, the anode pad 56 and the cathode pad 58 are formed on an extension portion 52b protruding from a plane portion 52a. Here, the ground pad 157 is on one surface of the extension portion 52b, and the anode pad 56 and the cathode pad 58 are formed on the other surface of the extension portion 52b, thereby reducing the width of the extension portion 52b, as compared to the case where all the pads are formed on one surface of the extension portion 52b.

The EMI shielding pattern 155 is formed to overlap the anode pattern 56 and the cathode pattern 58 which are formed on the plane opposite to the plane where the EMI shielding pattern is formed. That is to say, the EMI shielding pattern 155 is entirely formed on one surface of the first circuit board 52, and the anode pattern 56 and the cathode pattern 58 are formed on the other surface of the first circuit board 52.

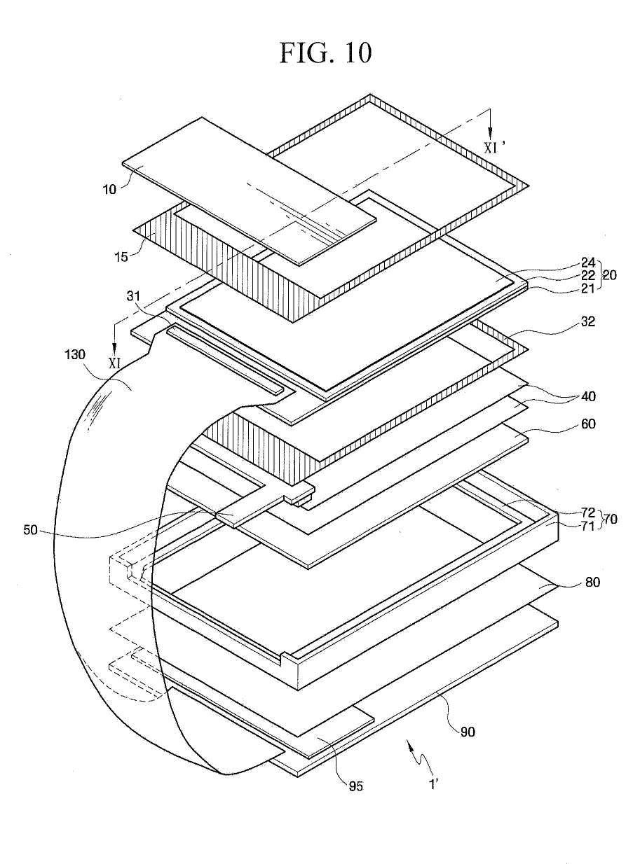

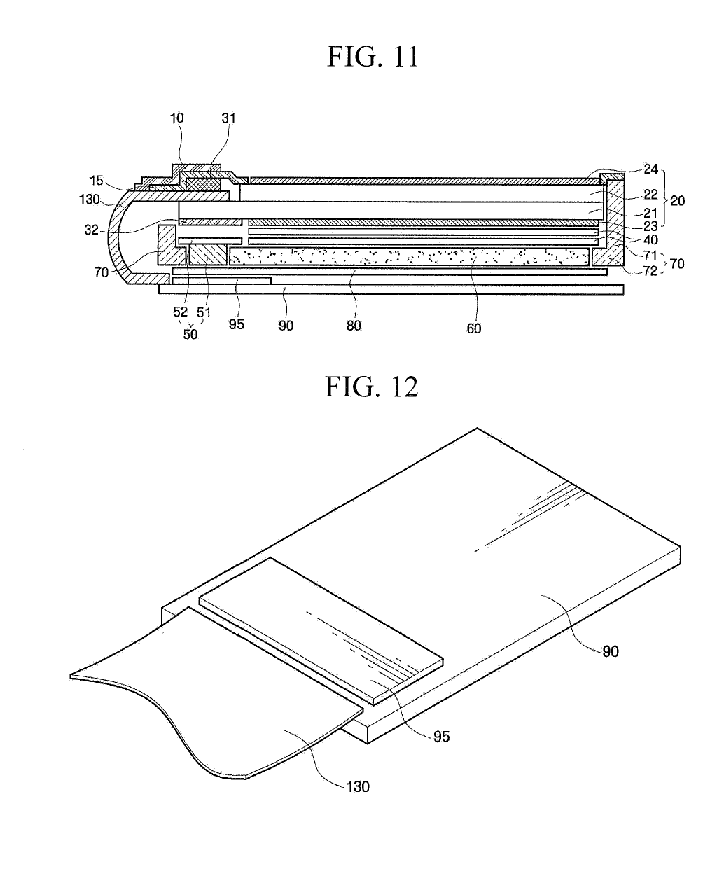

Hereinafter, a display device 1′ according to an exemplary embodiment of the present invention will be described in detail with reference to FIGS. 10 through 12. FIG. 10 is an exploded perspective view of a display device according to an exemplary embodiment of the present invention. FIG. 11 is a cross-sectional view of the display device shown in FIG. 10 taken along a line XI-XI′. FIG. 12 is a perspective view of a second circuit board included in the display device shown in FIG. 10. For the sake of illustrative convenience, elements identical to those in the previous exemplary embodiments are indicated by identical reference numerals, and detailed descriptions about the identical elements will be omitted.

The display device 1′ according to an exemplary embodiment of the present invention includes a second circuit board 90 connected to a display panel 20 through a flexible film 130, and an EMI shielding pattern 95 disposed on the second circuit board 90.

In the display device l′ some of various driving circuits for driving a display panel 20 are mounted on the second circuit board 90. The second circuit board 90 is disposed below a reflection sheet 80 and combined with the frame 70, thereby maintaining the strength of the display device 1′.

The second circuit board 90 is formed to entirely overlap the display panel 20. If necessary, the area of the second circuit board 90 may be minimized. Here, the EMI shielding pattern 95 may be formed with a size as needed at a location where it can overlap the driving chip 31.

The EMI shielding pattern 95 is formed on at least one of both surfaces of the second circuit board 90 by patterning. The EMI shielding pattern 95 is formed as a conductive film to then be attached the second circuit board 90. The EMI shielding pattern 95 is connected to a ground power supply.

The EMI shielding pattern 95 may be formed on the entire surface of the second circuit board 90 and a reflective material may be coated on its surface. As described above, a reflection sheet 80 can be omitted by coating the reflective material on the second circuit board 90, thereby simplifying the manufacturing process.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display device comprising:
a display panel that displays an image;
a light source that supplies light to the display panel; and
a first circuit board having the light source mounted thereon and an electromagnetic interference shielding pattern formed on at least one surface thereof.

2. The display device of claim 1, wherein the electromagnetic interference shielding pattern is connected to a ground power supply.

3. The display device of claim 1, wherein the first circuit board further comprises an anode pattern and a cathode pattern that supplies power to the light source.

4. The display device of claim 3, wherein the anode pattern and the cathode pattern are formed on a same plane as the electromagnetic interference shielding pattern.

5. The display device of claim 3, wherein at least one of the anode pattern and the cathode pattern is formed on a plane opposite to a plane where the electromagnetic interference shielding pattern is formed.

6. The display device of claim 5, wherein the anode pattern and the cathode pattern overlap the electromagnetic interference shielding pattern.

7. The display device of claim 3, wherein the anode pattern and the cathode pattern are formed along an edge of the first circuit board.

8. The display device of claim 3, wherein the electromagnetic interference shielding pattern is integrally formed at a central portion of the first circuit board.

9. The display device of claim 7, wherein the electromagnetic interference shielding pattern is surrounded by at least one of the anode pattern and the cathode pattern.

10. The display device of claim 1, further comprising a driving circuit provided on the display panel that drives the display panel.

11. The display device of claim 10, wherein the electromagnetic interference shielding pattern is disposed to overlap the driving circuit.

12. The display device of claim 10, further comprising an electromagnetic interference shielding film attached to the display panel to overlap the driving circuit, wherein the driving circuit is disposed between the electromagnetic interference shielding film and the electromagnetic interference shielding pattern.

13. The display device of claim 1, wherein the electromagnetic interference shielding pattern is disposed between the display panel and the light source.

14. A display device comprising:
a display panel that displays an image;
a light source that supplies light to the display panel;
a first circuit board having the light source mounted thereon;
a flexible film connected to the display panel; and
a second circuit board connected to the flexible film and having an electromagnetic interference shielding pattern formed on at least one plane thereof.

15. The display device of claim 14, wherein the electromagnetic interference shielding pattern is connected to a ground power supply.

16. The display device of claim 14, further comprising a driving circuit provided on the display panel that drives the display panel.

17. The display device of claim 16, wherein the electromagnetic interference shielding pattern is disposed to overlap the driving circuit.

18. The display device of claim 16, further comprising an electromagnetic interference shielding film attached to the display panel to overlap the driving circuit, wherein the driving circuit is disposed between the electromagnetic interference shielding film and the electromagnetic interference shielding pattern.

19. The display device of claim 14, wherein the electromagnetic interference shielding pattern is disposed between the display panel and the light source.

20. The display device of claim 16, further comprising a frame, wherein the frame is disposed between the display panel and the second circuit board.

21. A light source unit comprising:
a light source; and
a circuit board having the light source mounted thereon and having an electromagnetic interference shielding pattern formed on at least one plane of the circuit board.

22. The light source unit of claim 21, wherein the circuit board further comprises a anode pattern and a cathode pattern that supply power to the light source.

23. The light source unit of claim 22, wherein the anode pattern and the cathode pattern are formed on a same plane as the electromagnetic interference shielding pattern.

24. The light source unit of claim 22, wherein at least one of the anode pattern and the cathode pattern is formed on a plane opposite to the plane where the electromagnetic interference shielding pattern is formed.

25. The light source unit of claim 22, wherein the electromagnetic interference shielding pattern is integrally formed at a central portion of the circuit board.
